(19) United States
(12) Patent Application Publication
(10) Pub. No.: US 2019/0201761 A1
(43) Pub. Date: Jul. 4, 2019

(54) ACCESSORY DEVICE HOLDER SUITABLE FOR GOLF CART

(71) Applicant: Scott J. Danielson, Rockton, IL (US)

(72) Inventor: Scott J. Danielson, Rockton, IL (US)

(73) Assignee: Two Cards Innovation, LLC, Rockton, IL (US)

(21) Appl. No.: 15/859,864

(22) Filed: Jan. 2, 2018

(51) Int. Cl. A63B 57/20; A63B 47/00; F16M 11/14; F16M 11/04

(52) U.S. Cl. CPC A63B 57/20; A63B 47/00; A63B 2209/00; F16M 11/041; F16M 11/14

(57) ABSTRACT

An accessory holder and mount of an accessory holder for use with a golf ball holder of a golf cart are provided. The accessory mount includes a base and a stem. The base is substantially spherical with an outer diameter approximately the size of a regulation golf ball. The base is configured to be received and selectively secured within the golf ball holder. The stem extends between first and second ends. The first end is attached to the base and the second end is remote from the base and attached to the first device holder. The stem and base are sized and configured such that the base may be pivoted within the golf ball holder upon the application of an external force by a user to adjust an orientation of the stem relative to the golf ball holder.

### FIELD OF THE INVENTION

This invention generally relates to accessory holders for holding personal items such as personal electronics and particularly to accessory holders mountable to a golf cart using golf ball holders of the golf cart.

### BACKGROUND OF THE INVENTION

Golfers often have personal objects that it is desirable to see or otherwise have access to while golfing. For example, a golfer may want to be able to view their phone, a map of the hole they are currently playing that is viewable on a handheld electronic device, a golfer may have a device that plays music while they are golfing, etc.

Further, most golf carts and push carts include holders for holding golf balls for easy access to the golfer. These holders are typically sized to hold the golf ball without letting the golf ball roll around.

Accessory holders that utilize or otherwise mount to these golf ball holders are known. For example, U.S. Pat. No. 8,429,238 provides one such accessory holder. However, to provide the ability to adjust the position of the held accessory, a complex structure is required. Further, U.S. Pat. Appl. Publ. No. 2004/0182897 provides another such accessory holder. However, this device provides limited to no adjustability and also requires a golf ball itself for properly mounting the device to the golf cart.

The present invention provides improvements over the current state of the art.

### BRIEF SUMMARY OF THE INVENTION

Embodiments of new and improved accessory holders and mounts for accessory holders that cooperate with golf ball holders of a golf cart or a golf club push cart are provided. Embodiments provide simple manufacture while allowing for positional adjustability to allow for adjusting the viewing angle of any device held by the accessory holder. Golf cart as used herein shall be broad enough to encompass both driven carts and push carts.

In one embodiment, an accessory holder for mounting a device to a golf ball holder of a golf cart is provided. The golf ball holder has a cavity being sized and configured to selectively receive and hold one or more regulation size golf balls in a fixed position. The golf ball holder defines a mouth through which access to the cavity is provided, e.g. through which the golf ball is received into and removed from the cavity. The cavity may be spherical or an elongated channel. The accessory mount includes a first device holder, a base and a stem. The first device holder is configured to selectively hold an accessory such as a phone, GPS device, music player, etc. The base is substantially spherical with an outer diameter approximately the size of a regulation golf ball. The base is configured to be received and selectively secured within the golf ball holder. The stem extends between first and second ends. The first end is attached to the base and the second end is remote from the base and attached to the first device holder. The stem and base are sized and configured such that the base may be pivoted within the golf ball holder upon the application of an external force by a user to adjust an orientation of the stem relative to the golf ball holder.

In one embodiment, when the base is positioned within the golf ball holder, a clearance between the mouth and the stem is provided such that the orientation of the stem relative to the mouth can be adjusted by rotating the base within the golf ball holder.

In one embodiment, when the stem does not contact the golf ball holder, the base relies on frictional engagement with the golf ball holder to inhibit pivoting motion of the base relative to the golf ball holder.

In one embodiment, the base is formed from a central core and an outer layer around the inner core. The inner core has a hardness that is greater than a hardness of the outer layer. Compression of the outer layer between the inner core and the golf ball holder provides sufficient frictional engagement to inhibit pivoting motion of the base relative to the golf ball holder absent an external force (the external force not being gravity).

In one embodiment, the stem and the inner core are unitarily formed as a monolithic structure from a continuous piece of material.

In one embodiment, the base is configured such that when an accessory of at least 10 ounces is mounted within the first device holder, the base will not pivot within the golf ball holder under the weight of the device if the stem extends from the golf ball holder in a cantilevered orientation.

In one embodiment, the first device holder is removably attachable to the second end of the stem. A second device holder is removably attachable to the second end of the stem. The first device holder is configured to hold an accessory of a first size or shape. The second device holder is configured differently than the first device holder and configured to hold an accessory of a second size or shape. The second size or shape is different than the first size or shape.

In one embodiment, the outer layer is formed from one of a thermoplastic elastomer, silicone or a rubberized material.

In an embodiment, an accessory mount for mounting a device holder that mounts a device to a golf ball holder of a golf cart is provided. The golf ball holder has a cavity being sized and configured to selectively receive and hold one or more regulation size golf balls in a fixed position. The golf ball holder defines a mouth through which access to the cavity is provided. The cavity may be spherical or an elongated channel. The accessory mount includes a base and a stem. The base is substantially spherical with an outer diameter approximately the size of a regulation golf ball configured to be received and selectively secured within the golf ball holder. The base includes an inner core and an outer layer around the inner cor. The inner core has a hardness that is greater than a hardness of the outer layer. Further, when the base is inserted into the golf ball holder, the outer layer compresses between the golf ball holder and the inner core to create frictional engagement between the base the golf ball holder to inhibit movement of the base relative to the golf ball holder. The stem extends between first and second ends. The first end is attached to the base and the second end is remote from the base.

In one embodiment, the stem and the inner core are unitarily formed as a monolithic structure from a continuous piece of material.

In one embodiment, the base is configured such that when an accessory of at least 10 ounces is mounted within a device holder attached to an end of the stem, the base will not pivot within the golf ball holder under the weight of the device, in particularly, if the stem extends from the golf ball holder in a cantilevered orientation. This prevention of pivoting movement in these conditions is provided solely by way of frictional engagement between the base and the golf ball holder.

In one embodiment, an outer periphery of the outer layer includes surface texture that provides increased gripping engagement with the golf ball holder. For example, dimples or projections may be provided.

In one embodiment, first and second device holders that are removably attachable to the second end of the stem are provided. The first device holder is configured to hold an accessory of a first size or shape. The second device holder is configured to hold an accessory of a second size or shape. The second size or shape being different than the first size or shape.

In an embodiment, an accessory mount for mounting a device to a golf ball holder of a golf cart is provided. The golf ball holder has a cavity being sized and configured to selectively receive and hold one or more regulation size golf balls in a fixed position. The golf ball holder defines a mouth through which access to the cavity is provided. The accessory mount includes a base and a stem. The base is substantially spherical with an outer diameter sized to be received and selectively secured within the golf ball holder as well as selectively removable from the golf ball holder through the mouth. The stem extends between first and second ends. The first end is attached to the base and the second end is remote from the base. The stem and base are sized and configured such that a clearance is provided between the stem and the golf ball holder such that the base may be pivoted within the golf ball holder about at least two axes upon the application of an external force by a user to adjust an orientation of the stem relative to the golf ball holder. The base is sized and configured such that, when an accessory of at least 10 ounces is operably mounted proximate the second end of the stem, the friction-fit engagement between the base and the golf ball holder prevents the base from pivoting about the at least two axes within the golf ball holder under the weight of the device if the stem extends from the golf ball holder in a cantilevered orientation and the stem is not in engagement with the golf ball holder.

In one embodiment, the base is formed from a central core and an outer layer around the inner core, the inner core having a hardness that is greater than a hardness of the outer layer.

In one embodiment, the stem and the inner core are unitarily formed as a monolithic structure from a continuous piece of material.

In one embodiment, the outer layer is formed from one of a thermoplastic elastomer, silicone or a rubberized material.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view illustration of an accessory holder according to an embodiment of the invention mounted to a golf ball holder of a golf cart;

FIG. 2 is a perspective illustration of the mount of the accessory holder;

FIG. 3 is a cross-sectional illustration of the mount of FIG. 2;

FIGS. 4 and 5 are simplified illustrations of a first device holder usable with the mount of FIG. 2; and

FIGS. 6 and 7 are simplified illustrations of a second device holder usable with the mount of FIG. 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

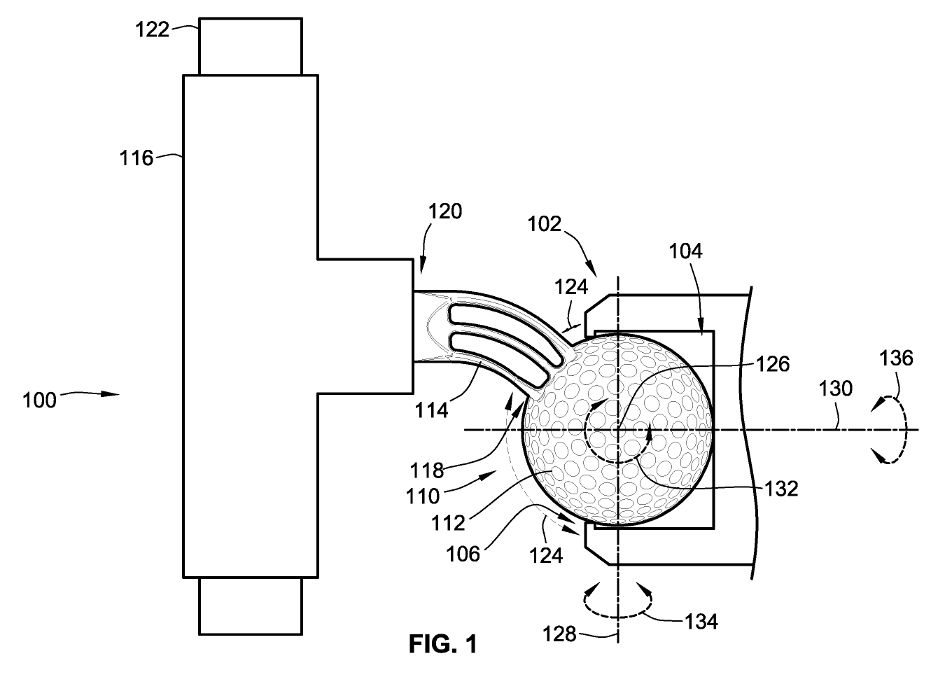

FIG. 1 illustrates an accessory holder 100 according to an embodiment of the invention. The accessory holder 100 is mounted within a golf ball holder 102 of a golf cart or a push cart.

The golf ball holder 102 defines a cavity 104 in which the golf ball holder 100 is operably mounted. A mouth 106 of the golf ball holder 100 provides access to the cavity 104. Typically, the golf ball holder is sized and configured to releasably receive a regulation sized golf ball for securing the golf ball therein in a fixed position. The golf ball may be held in the holder 102 by way of friction-fit or as illustrated in FIG. 1, an interference fit may be provided where the diameter of the golf ball is greater than a corresponding dimension of the mouth 106. Further, the cavity 104 may be an elongated channel such that multiple golf balls may be located therein in direct side-by-side relation or a generally partial sphere such that only a single golf ball may be located in the cavity 104 at a time. In the elongated designs, it is typical that the engagement between the golf ball holder 102 and golf ball is such that the ball will not move axially within elongated channel without applying an external force, e.g. by a user. Typically, the golf ball holder 102 is substantially flexible to allow for flexure of the mouth 106 to allow for inserting and removing the golf ball from the cavity 104.

With the background of the golf ball holder 102 now provided, the he accessory holder 100 will be described. The accessory holder 100 includes an accessory mount 110 (also referred to as mount 110). The mount 110 includes a base 112, a stem 114 and a device holder 116.

The base 112 is configured to be received through the mouth 106 and secured within cavity 104. In the illustrated embodiment, the base 112 simulates the shape and look of a golf ball. As such, the base 112 is substantially spherical and has an outer diameter that is substantially the size of a regulation golf ball.

The stem 114 extends between first and second ends 118, 120. The first end 118 is operably attached to the base 112 and the second end 120 is operably attached to the device holder 116 at a location remote from base 112. In one embodiment, the stem 114 and base 112 are unitarily formed as a monolithic structure. In other embodiments, the stem is removably attachable to the base. Similarly, the stem 114 may be unitarily formed with the device holder 116. Alternatively, the device holder 116 is removably attachable to the stem 114. It is preferred that the device holder 116 be operably removably attachable to the base 112 such that the device holder 116 can be changed between different types of device holders that may have different configurations for holding different devices 122 of different sizes or shapes. The device holder 116 and device 122 are simply illustrated in schematic form and are not to scale, shape or size.

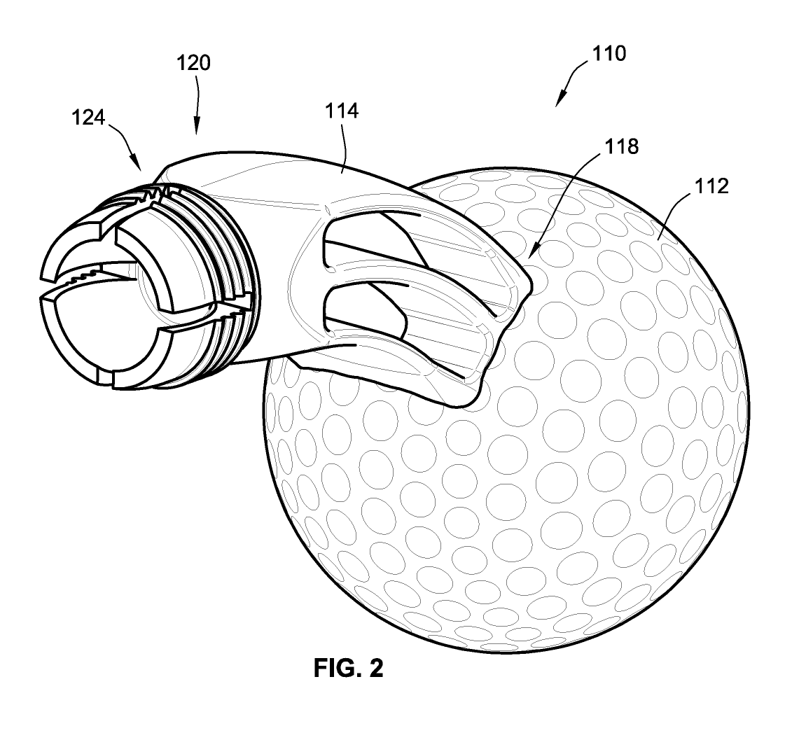

With reference to FIG. 2, the second end 120 of stem 114 includes threaded connector 124 that allows different device holders 116 to be releasably attached to the mount 110. The device holder 116 would have a cooperating threaded connector for securement to stem 114. Other connections are contemplated. Further, it is contemplated that the device holder 116, stem 114, and base 112 could be a single piece of material. However, such a device would not be able to be reconfigured to be used with different device holders 116.

With reference to FIG. 1, the stem 114 is configured such that a clearance (illustrated by arrows 124) is provided between the stem 114 and the golf ball holder 102 when the mount 112 is positioned within cavity 104. This clearance 124 permits pivoting motion of the mount 110, and particularly base 112, about first, second and third axes 126, 128, 130 illustrated by arrows 132, 134, 136, respectively. This ability to pivot the mount 110 allows for the user to reorient the device holder 116 such that it is easier to view a held device 122. More particularly, a user would apply an external force to the mount 110, typically to the device holder 116 or the stem 114, to cause the base 112 to pivot within cavity 104 about any one of axes 126, 128, 130. This generally allows for pivoting motion in three dimensions.

The base 112 is sized and configured such that a frictional-fit between the outer periphery of the base 112 and the golf ball holder 102 prevents movement of the mount 110 absent the application of an external force (i.e. something other than gravity). More particularly, when the stem 114 extends outward in a cantilevered orientation from the base 112 and golf ball holder 102 and the stem 112 does not rest vertically against the golf ball holder, such as illustrated in FIG. 1, the friction-fit provides sufficient frictional forces to prevents movement of the base 112 relative to the golf ball holder 102. More particularly, the torque generated due to the weight of the stem 114, device holder 116 and device 122, will not cause movement of the base 112. In one implementation, the frictional-fit (also referred to as “frictional engagement”) is sufficient to prevent movement when a device of at least 10 ounces is held by the device holder 116.

However, the frictional engagement between the base 112 and the golf ball holder 102 is not so great that a user cannot pivot the base 112 within the golf ball holder 102 to reorient the device holder 116 when applying an appropriate external force.

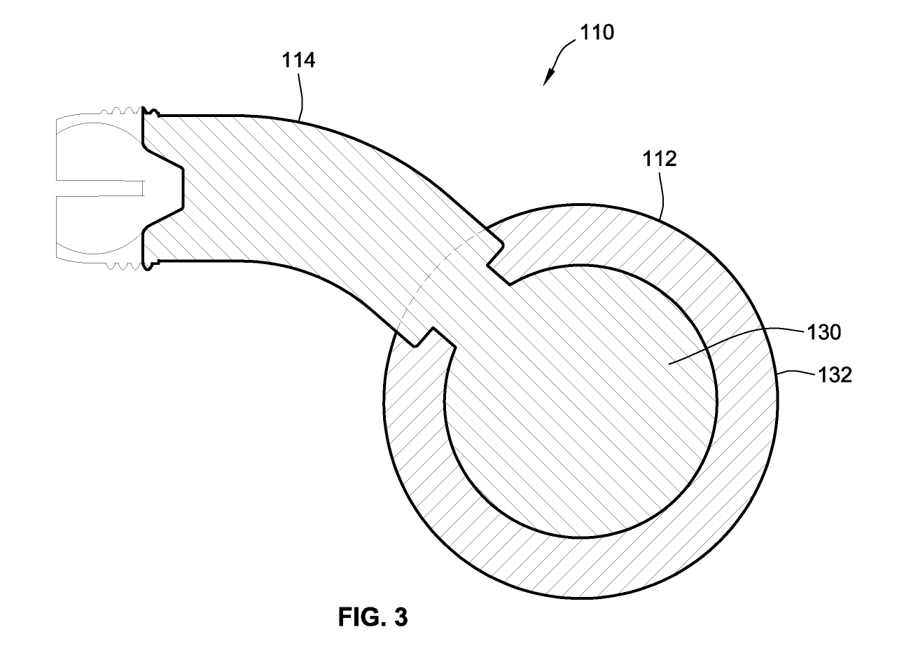

With reference to FIG. 3, the base 112 includes a central core 130 and an outer layer 132. In a preferred implementation, the inner core 130 is formed from a harder material than the outer layer 132. This allows the outer layer 132 to be compressed between the inner core 130 and the golf ball holder 102 and provide the appropriate frictional engagement to prevent undesired pivoting. In a preferred embodiment, the inner core 130 is unitarily formed with stem 114 as a monolithic piece of material. In one embodiment, this material is a plastic.

In a preferred embodiment, the mount 110 is formed from a two-shot molding process. To provide appropriate frictional engagement, the outer layer is preferably formed from a rubber-like material such as a thermoplastic elastomer, a silicone or a rubberized material.

Further, the outer periphery of the base 112 may include surface texturing such as dimples or projections to increase the frictional engagement with the golf ball holder.

The compressible nature of the outer layer 132 allows for easy insertion and mounting of the device and an appropriate level of frictional engagement without requiring any moving components and portions that are external of the cavity 104 and in engagement with the golf ball holder 102.

The outer periphery may be slightly smaller or larger than a regulation golf ball depending on the material forming the exterior surface of the base 112, depending on the degree of compression of the material forming the exterior surface that is necessary for providing appropriate frictional engagement between the base 112 and the golf ball holder 102. As such, an outer diameter that is substantially or approximately the size of a regulation golf ball will encompass such slight variations from such standards, such as a variation of plus or minus 3.5 mm in diameter. Typically, the variation will be larger than the standard size of a golf ball so as to increase the frictional engagement. How

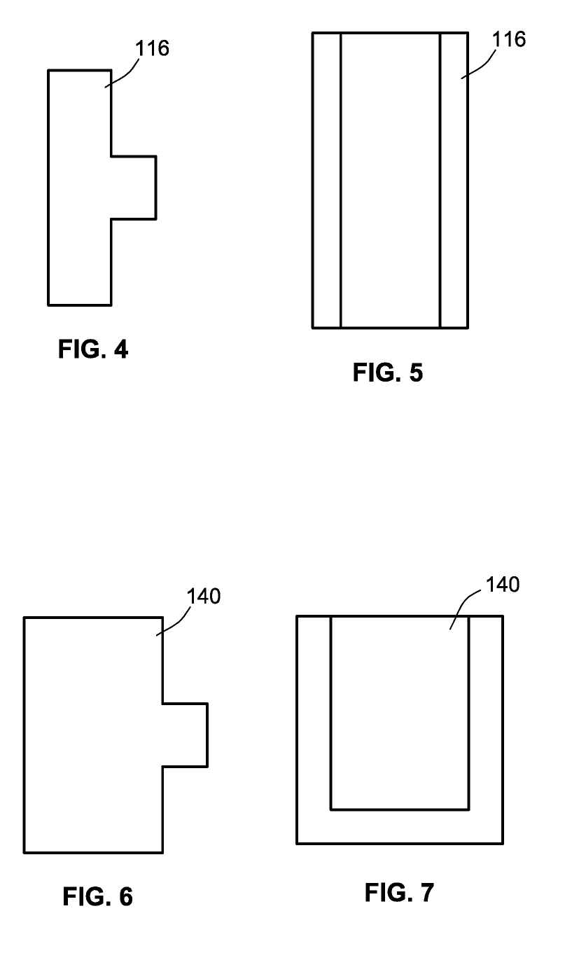

FIGS. 4 and 5 illustrate, in schematic form, the first device holder 116. FIGS. 6 and 7, illustrate a second device holder 140 in schematic form. Each of these device holders 116, 14 may be operably attached to stem 114 depending on the size and configuration of the device 122 to be held. These two device holders 116, 140 illustrate that device holders of different size and/or configuration can be provided. Device holder 116 clamps the accessory thereto. Device holder 140 provides slot and a bottom shelf that vertically supports an accessory.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. An accessory holder for mounting a device to a golf ball holder of a golf cart, the golf ball holder having a cavity being sized and configured to selectively receive and hold one or more regulation size golf balls in a fixed position, the golf ball holder defining a month through which access to the cavity is provided, the accessory holder comprising;
a first device holder for selectively holding an accessory;
a base being configured to be received and selectively secured within the golf ball holder,
a stern extending between first and second ends the first end being attached to the base and the second end being remote from the base and attached to the first device holder, the stem and base being sized and configured such that the base may be pivoted within the golf ball holder upon the application of an external force by a user to adjust an orientation of the stem relative to the golf ball holder;
the base being a sphere except for where the stem is attached to the base, the base having an enter diameter approximately the size of a regulation gold ball;
the entirety of the base that engages the golf ball holder when inserted into the golf ball holder being a unitary component when removed from the golf ball holder, and
wherein when the base is positioned within the golf ball holder, a clearance between the mouth and the stem is provided such that the orientation of the stem relative to the mouth can be adjusted by rotating the base within the golf ball holder about three perpendicular axes while the base remains secured within the golf ball holder while remaining secured within the golf ball holder.

3. An accessory bolder for mounting a device to a golf ball holder of a golf cart, the golf ball holder having a cavity being sized and configured to selectively receive and hold one or more regulation size golf balls in fixed position, the golf ball holder defining a mouth through which access to the cavity is provided, the accessory holder comprising:
a first device holder for selectively holding an accessory;
a base being configured to be received and selectively secured within the golf ball holder;
a stem extending between first and second ends, the first end being attached to the base and the second end being remote from the base and attached to the fast device holder, the stem arid base being sized and configured such that the base may be pivoted within the golf ball holder upon the application of an external force by a user to adjust an orientation of the stem relative to the golf ball holder:
the base being a sphere except for where the stem is attached to the base, the base having an outer diameter approximately the size of a regulation golf ball: and
the entirety of the base that engages the golf ball holder when inserted into the golf ball holder being a unitary component when removed from the golf ball holder.
when the stem does not contact the gold ball holder, the base relies on frictional engagement with the golf ball holder to inhibit pivoting motion of the base relative to the golf ball holder.

4. The accessory holder of claim 2, wherein the base is formed from an inner core and an outer layer around the inner core, the inner core having a hardness that is greater than a hardness of the outer layer.

5. The accessory holder of claim 4, wherein the stem and the inner core are unitarily formed as a monolithic structure from a continuous piece of material.

6. An accessory holder for mounting a device to a golf ball holder of a golf cart, the golf ball holder having a cavity being sized and configured to selectively receive and hold one or more regulation size gold balls in a fixed position, the gold ball holder defining a mouth through which access to the cavity is provided, the accessory holder comprising:
a first device holder for selectively holding an accessory,
a base having configured to be received and selectively secured within the gold ball holder;
a stem extending between first and second ends, the first end being attached to the base and the second end being remote from the base and attached to the fist device holder, the stem and base being sized and configured such that the base may be pivoted within the golf ball holder upon the application of an external force by a user to adjust an orientation of the stem relative to the golf ball holder;
the base being a sphere except for where the stem is attached to the base, the base having an outer diameter approximately the size of a regulation golf ball; and
the entirety of the base that engages the golf ball holder when inserted into the golf ball holder being a unitary component when removed from the golf ball holder.
wherein the base is configured such that when an accessory of 10 ounces is mounted within the first device holder, the base will not pivot within the golf ball holder under the weight of the device if the stem extends from the golf ball holder in a cantilevered orientation and without the stem in contact with the golf ball holder.

7. The accessory holder of claim 2, wherein the first device holder is removably attachable to the second end of the stem, further comprising a second device holder that is removably attachable to the second end of the stem;
the first device holder configured to hold an accessory of a first size or shape;
the second device holder being configured differently than the first device holder and configured to hold an accessory of a second size or shape, the second size or shape being different than the first size or shape.

8. The accessory holder of claim 4, wherein the outer layer is formed from one of a thermoplastic elastomer, silicone or a rubberized material.

9. An accessory mount for mounting a device to a golf ball holder of a golf cart, the golf ball holder having a cavity being sized and configured to selectively receive and hold one or more regulation size golf balls in a fixed position, the golf ball holder defining a mouth through which access to the cavity is provided, the accessory holder comprising:
a base configured to be received and selectively secured within the golf ball holder, the base including an inner core and an outer layer around the inner core, the inner core having a hardness that is greater than a hardness of the outer layer, such that when the base is inserted into the golf ball holder, the outer layer compresses between the golf ball holder and the inner core to create frictional engagement between the base the golf ball holder to inhibit movement of the base relative to the golf ball holder;
a stem extending between first and second ends, the first end being attached to the base and the second end being remote from the base;
the base being a sphere except for where the stem is attached to the base, the base having an outer diameter approximately the size of a regulation golf ball; and
the entirety of the base that engages the golf ball holder to provide the frictional engagement with the golf ball holder when inserted into the golf ball holder being a unitary component when removed from the golf ball holder, and
wherein the base is configured such that when an accessory of 10 ounces is mounted within a device holder attached to an end of the stem, the base will not pivot within the golf ball holder under the weight of the device if the stem extends from the golf ball holder in a cantilevered orientation solely by way of frictional engagement between the base and the golf ball holder and when the stem is not in engagement with the golf ball holder.

10. The accessory mount of claim 9, wherein the stem and the inner core are unitarily formed as a monolithic structure from a continuous piece of material.

11. (canceled)

12. The accessory mount of claim 9, wherein an outer periphery of the outer layer includes surface texture that provides increased gripping engagement with the golf ball holder.

13. The accessory mount of claim 9, further comprising first and second device holders that are removably attachable to the second end of the stem;
the first device holder being configured to hold an accessory of a first size or shape;
the second device holder being configured to hold an accessory of a second size or shape, the second size or shape being different than the first size or shape.

14. An accessory mount for mounting a device to a golf ball holder of a golf cart, the golf ball holder having a cavity being sized and configured to selectively receive and hold one or more regulation size golf balls in a fixed position, the golf ball holder defining a mouth through which access to the cavity is provided, the accessory mount comprising:
a base with an outer diameter sized to be received and selectively secured within the golf ball holder and selectively removable from the golf ball holder through the mouth; and
a stem extending between first and second ends, the first end being attached to the base and the second end being remote from the base, the stem and base being sized and configured such that a clearance is provided between the stem and the golf ball holder such that the base may be pivoted within the golf ball holder about three perpendicular axes upon the application of an external force by a user to adjust an orientation of the stem relative to the golf ball holder;
the base being sized and configured such that when an accessory of 10 ounces is operably mounted proximate the second end of the stem, a friction-fit engagement between the base and the golf ball holder prevents the base from pivoting about the at least two axes within the golf ball holder under the weight of the device if the stem extends from the golf ball holder in a cantilevered orientation and the stem is not in engagement with the golf ball holder;
the base being a sphere except for where the stem is attached to the base, the base having an outer diameter approximately the size of a regulation golf ball; and
the entirety of the base that engages the golf ball holder to provide the friction-fit engagement with the golf ball holder when inserted into the golf ball holder being a unitary component when removed from the golf ball holder.

15. The accessory mount of claim 14, wherein the base is formed from an inner core and an outer layer around the inner core, the inner core having a hardness that is greater than a hardness of the outer layer.

16. The accessory mount of claim 15, wherein the stem and the inner core are unitarily formed as a monolithic structure from a continuous piece of material.

17. The accessory mount of claim 15, wherein the outer layer is formed from one of a thermoplastic elastomer, silicone or a rubberized material.

18. The accessory mount of claim 14, further comprising first and second device holders that are removably attachable to the second end of the stem;
the first device holder being configured to hold an accessory of a first size or shape;
the second device holder being configured to hold an accessory of a second size or shape, the second size or shape being different than the first size or shape.

19. The accessory mount of claim 2, wherein the entirety of the base that engages the golf ball holder to secure the base within the golf ball holder and the stem are unitary with one another such that when the base is removed from golf ball holder the entirety of the base that engages the golf ball holder to secure the base within the golf ball holder and the stem remain affixed to one another as a unitary component.

20. The accessory mount claim 2, wherein the stem and the entirety of the base that engages the golf ball holder to secure the base within the golf ball holder are permanently affixed to one another.

21. The accessory mount of claim 2, wherein the base has the shape and look of a golf ball except for where the stem is attached to the base.

22. An accessory holder for mounting a device to a golf ball holder of a golf cart, the golf ball holder having a cavity being sized and configured to selectively receive and hold one or more regulation size golf balls in a fixed position, the golf ball holder defining a mouth through which access to the cavity is provided, the accessory holder comprising:
a first device holder for selectively holding an accessory;
a base being configured to be received and selectively secured within the golf ball holder;
a stem extending between first and second ends, the first end being attached to the base and the second end being remote from the base and attached to the first device holder, the stem and base being sized and configured such that the base may be pivoted within the golf ball holder upon the application of an external force by a user to adjust an orientation of the stem relative to the golf ball holder;
the base having the shape and look of a golf ball except for where the stem is attached to the base, the base having an outer diameter approximately the size of a regulation golf ball; and
the entirety of the base that engages the golf ball holder when inserted into the golf ball holder being a unitary component when removed from the golf ball holder, and
wherein when the base is positioned within the golf ball holder, a clearance between the mouth and the stem is provided such that the orientation of the stem relative to the mouth can be adjusted by rotating the base within the golf ball holder about three perpendicular axes while the base remains secured within the golf ball holder while remaining secured within the golf ball holder.
